(19) United States
(12) Patent Application Publication
(10) Pub. No.: US 2009/0313258 A1
(43) Pub. Date: Dec. 17, 2009

(54) SYSTEMS, METHODS, AND COMPUTER PROGRAM PRODUCTS FOR CREATING SERVICE ORDER CONTROL SYSTEM REPORTS

(75) Inventor: David Villars, Fayetteville, GA (US)

Correspondence Address: AT&T Legal Department - CC;Attn: Patent Docketing, Room 2A-207, One AT&T Way, Bedminster, NJ, 07921, US

(73) Assignee: AT&T Delaware Intellectual Property, Inc., Wilmington, DE (US)

(21) Appl. No.: 12/139,677

(22) Filed: Jun. 16, 2008

(51) Int. Cl. G06F 17/30

(52) U.S. Cl. 707/10; 707/E17.001

(57) ABSTRACT

Methods, computer program products, and systems are provided for creating a service order control system (SOCS) report. SOCS data is received from a SOCS database, and input in regard to configuring an output format for a SOCS status report is received. The input includes information detailing at least one data field that will be comprised within the SOCS status report. The SOCS data that is respectively associated with each data field comprised within the SOCS status report is retrieved. As a result, a SOCS status report is generated.

### BACKGROUND

Exemplary embodiments relate generally to telecommunications, and more particularly, to the creation of service order control system reports.

Within the telecommunications industry, the Service Order Control System (SOCS) is utilized to process and track customer service orders until the completion of the service order's requested service. Typically, a company may receive hundreds of thousands of orders per month requesting service orders, wherein the services requested within these service orders may be non-centrally assigned to differing departments within an organization. As such, any order information that corresponds with a respective service order may not be centrally located for ease of access. As a result, in an effort to obtain specifically needed information pertaining to a work order, personnel within differing departments may not have access to the data or limited access to general service order information since the complete service order may not be easily accessed with a non-originating department that may be concurrently servicing the work order.

### BRIEF SUMMARY

Exemplary embodiments include a system for creating service order control system reports. The system includes a service order control system database stored at a storage device. The system further includes at least one server that is in communication with the service order control system database. The server includes a service order control system report generating application configured to deliver service order control system data from the server based upon input received at a remotely located computer system that is in communication with the server.

Additional exemplary embodiments include a method for creating service order control system reports. The method includes receiving service order control system data from a SOCS database and configuring an output format for a service order control system status report by determining at least one data field that will be comprised within the SOCS status report. The method further includes retrieving service order control system data that is respectively associated with each data field included within the service order control system status report and generating a service order control system status report.

Further exemplary embodiments include a computer program product that includes a computer readable medium useable by a processor. The medium includes a sequence of instructions which, when executed by the processor, causes the processor to create a service order control system report by receiving service order control system data from a service order control system database and receiving input for configuring an output format for the service order control system status report. The input includes information detailing at least one data field that will be included within the service order control system status report. The sequence of instructions further cause the processor to create the service order control system report by retrieving the service order control system data that is respectively associated with each data field comprised within the service order control system status report and generating the service order control system status report.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a system for the creation of SOCS reports from SOCS database information in accordance with exemplary embodiments;

FIG. 2 is a flow diagram of a methodology for the creation of custom SOCS reports in accordance with exemplary embodiments; and

FIG. 3 is a screenshot of a graphical user interface (GUI) showing data fields that may be utilized to create a customized SOCS report in accordance with exemplary embodiments.

FIG. 4 is a screenshot of a customized SOCS report generated in accordance with exemplary embodiments.

The detailed description explains the exemplary embodiments, together with advantages and features, by way of example with reference to the drawings.

### DETAILED DESCRIPTION OF EXEMPLARY EMBODIMENTS

One or more exemplary embodiments are described below in detail. The disclosed embodiments are intended to be illustrative only since numerous modifications and variations therein will be apparent to those of ordinary skill in the art.

Exemplary embodiments provide a solution for allowing a computing system user to create a customized report that is based upon service order control system (SOCS) data that is obtained from a daily SOCS data feed. The SOCS data may include specific service order data, such as but not limited to: state, district, order number NPANXX, service order status, class of service, etc. As such, a system user has the capability to create ad-hoc SOCS reports on-the-fly. The customized SOCS reports can be associated with the user's system login information and thereafter saved at a requested location or database. Within further exemplary embodiments, the customized SOCS report can be saved with a predetermined file format (e.g., HTML, XML, Excel, etc.) and exported to a secondary software application for further processing. Thus, a user is provided with the capability to filter out any undesired SOCS data from the data feed and capture the SOCS data that the user considers to be beneficial to their final custom SOCS report.

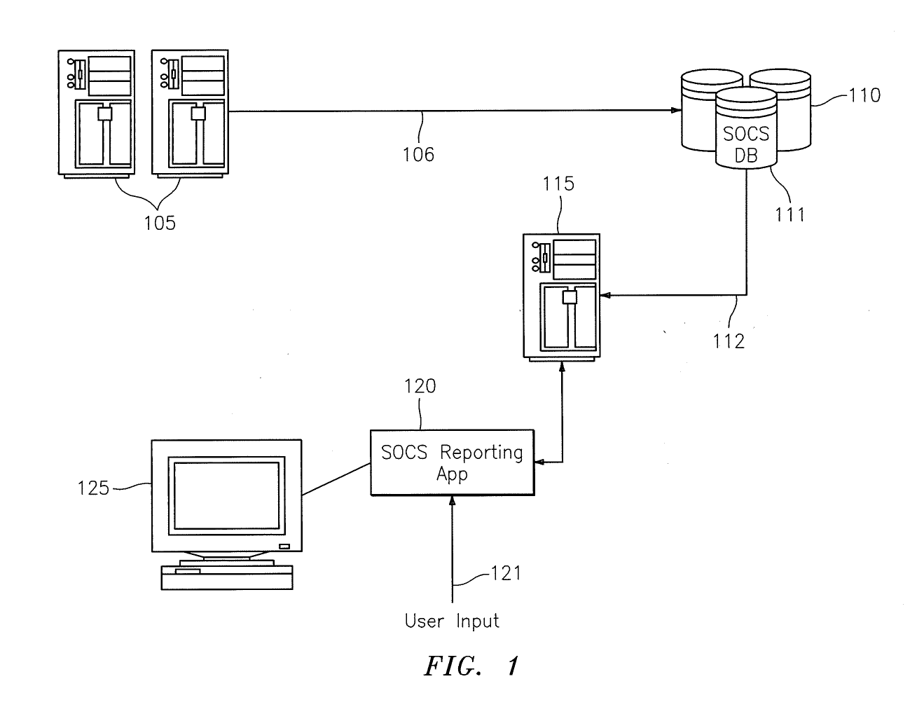

As shown in FIG. 1, a remotely located computer system 125 executing a SOCS reporting application 120 is in communication with a server 115. The server 115 is the recipient of a periodic SOCS data feeding operation 112 from a storage device 110a SOCS database 111 for a business enterprise. The SOCS data for the business enterprise may be delivered 106 from dedicated SOCS servers 105 to the SOCS database 111 at the storage device 110 for storage. The computer system 125 includes hardware and software elements conventionally included in personal computers (such as a keyboard, a processor, a storage device such as a hard disk drive, input/output interfaces, and a network interface). The computer system 125 has other hardware and software elements of the types conventionally included in personal computers, such as an operating system, but these are not shown for purposes of clarity.

The SOCS reporting application 120 can reside locally at the computer system 125 or remotely at the server 115. As such, the SOCS reporting application 120 can be executed locally at the computer system 125 or accessed at the server 115 (e.g., by way of a web browser operating at the computer system 125) via an established client/server relationship between the computer system 125 and the server 115.

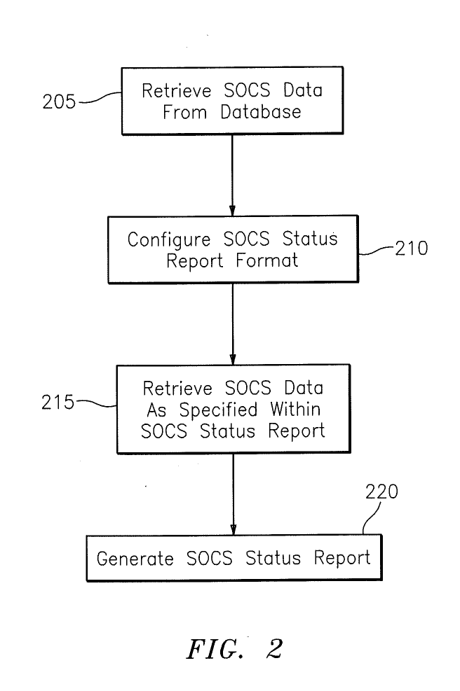

FIG. 2 shows an exemplary embodiment of a flow diagram detailing a methodology for the creation of SOCS reports. At step 205 SOCS data from the SOCS database 111 stored at the storage device 110 is delivered to the server 115. According to exemplary embodiments, the SOCS data is a collective representation of the current status of all outstanding service orders that are pending within the operations of a business enterprise. The SOCS data is compiled at the dedicated SOCS servers 105. At predetermined time intervals (e.g., on a daily time period schedule) the SOCS data that is stored within the SOCS database 111 is delivered to the server 115. In one embodiment, the SOCS data may be requested to be delivered from the database 111 to the server 115.

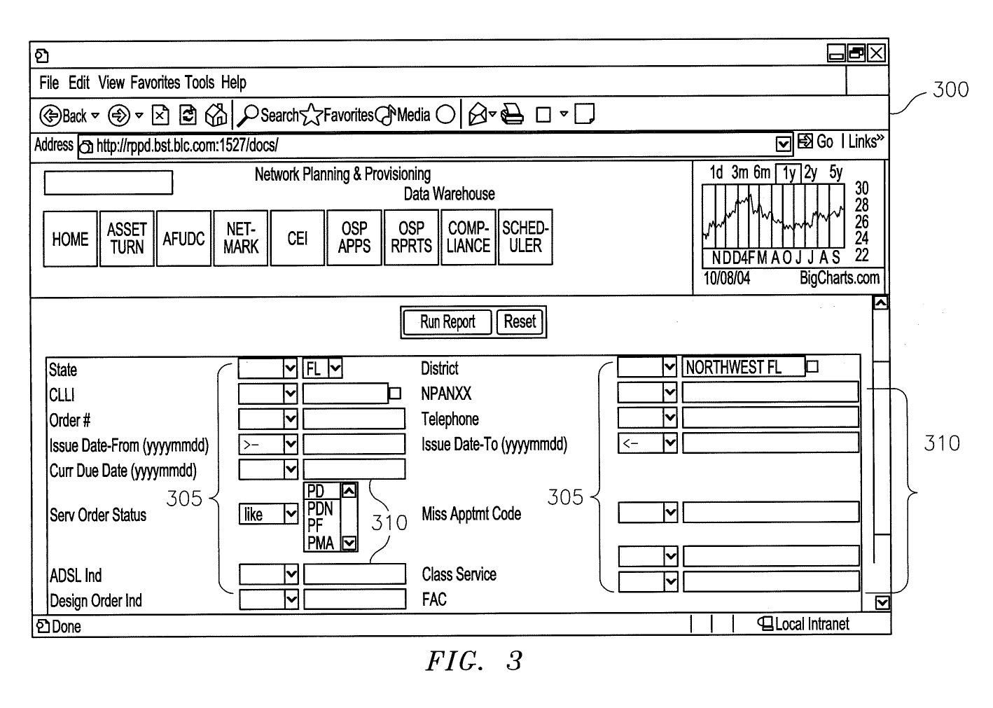

At step 210, a user of the computing system 125 logs into a network at the computing system 125 in order to accesses the SOCS reporting application 120. Once the user initiates the execution of the SOCS application 120 to start a processing job, the user may be presented with a GUI that allows the user to input information 121 to configure the output data that will be contained within a SOCS status report. This aspect is accomplished by the computing system 125 user determining at least one data field that will be comprised within the final SOCS status report. A screenshot 300 of an exemplary GUI interface is shown in FIG. 3. As illustrated in FIG. 3, the GUI interface may include a plurality of data fields. According to exemplary embodiments, each data field shown in the screenshot 300 of FIG. 3 is representative of fields of data that can be captured from the SOCS data that has been downloaded to the server 115.

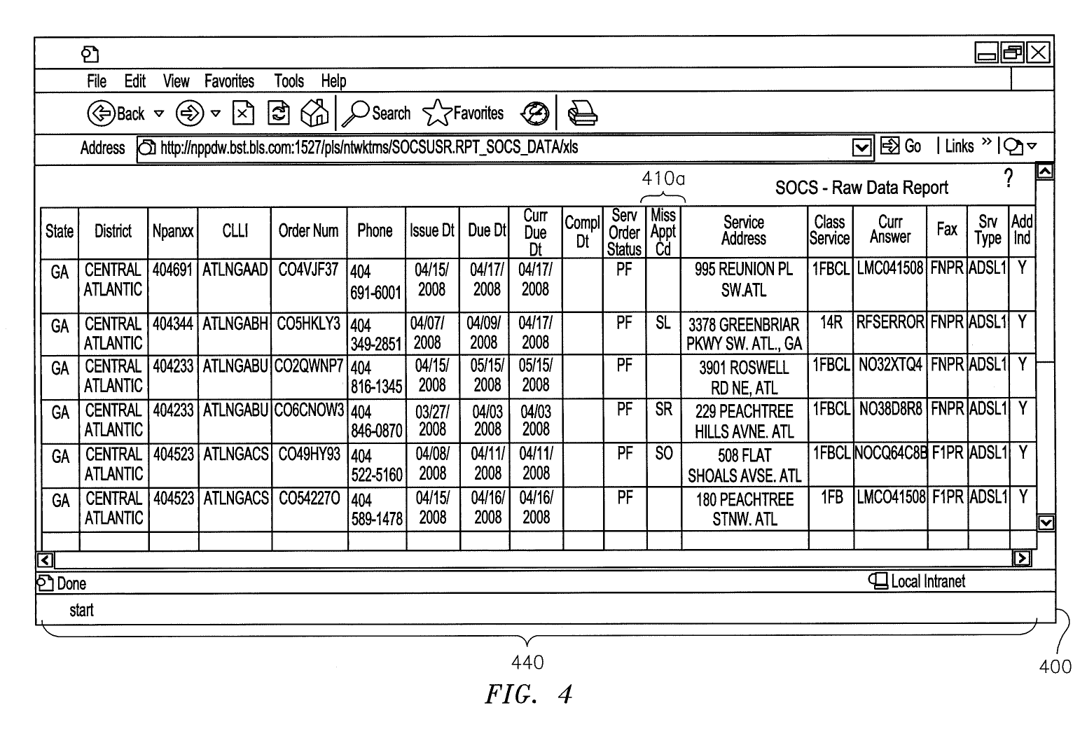

As shown in the screenshot 300 of FIG. 3, the GUI data fields can comprise a plurality of pull-down control boxes 305 or data search term fields 310 wherein SOCS data search terms may be manually entered at the GUI. The boxes 305 and data search term fields 310 permit user to customize reports for to obtain data regarding, e.g., specific states, districts, order nos., etc. The boxes 305 and search term fields 310 in FIG. 3 are shown by way of examples. These fields and data search terms may be different than that shown, depending on the needs of the user. Upon the computer system 125 user's submittal of the SOCS customization report request, at step 215 the specified SOCS data is retrieved from the server 115 by the SOCS application 120. At step 220, the SOCS application 120 generates the custom SOCS status report. The final report may be graphically displayed to the computer system 125 user at the computing system 125. Further, the generated SOCS report can be output in a predetermined data format (.e.g., HTML, XML, Excel, etc.) and exported to a secondary application. An exemplary screenshot showing SOCS output data is shown in FIG. 4.

Within further exemplary embodiments, generated SOCS status reports are associated with the login verification/validation information of the computer system 125 user that initiated the SOCS status report generating job. As such, a series of reports that are created by a user can be associated with one another and stored any determined location. Yet further, the respective SOCS status reports that have been generated by a user can be prioritized according to a predetermined report service type that can be assigned to each SOCS status report upon its creation. For example, if a user of the SOCS status reports needs the same reports run daily, then that user can customize a report based on the fields desired by that user, save the parameters of the report, give that report a unique name, and then run that specific report each day. According to an exemplary embodiment, this customized report may be saved only for a specific user based on the user's login.

FIG. 4 illustrates an exemplary screenshot 400 showing a SOCS status report containing raw data collected in a manner set by a user. The report can specifically return data that is for certain types of orders or orders that have certain data that the user may want in predefined places on a service order. In the screenshot shown in FIG. 4, there may be various predefined fields (and/or user-defined) fields 410, which may be populated with data as reports are run. As shown in FIG. 4, these fields may include, e.g., the state, district, NPANXX, CLLI, order number, and phone number for which the report is run. Theses fields may also include the issue date, due date, current due date and completion date of orders for which the report is run. Still further, these fields may include the service order status, a missed appointment code, the service address, the class of service, etc.

Using the missed appointment code field 410a as an example, not all service orders will have data reported in the missed appointment code field. Thus, there are some orders shown on the report for which there is no information contained in the missed appointment code field 410a. But, if a customer's due date is missed, this field may be populated with a code to track why a customer's due date was missed. According to an exemplary embodiment, missed appointment codes may have two alphabetic characters. For example, missed appointment codes beginning with “S” may indicate that the appointment was missed due to the customer, e.g., the customer wanted the date changed or order changed, the subscriber wasn't ready or available, etc. If the missed appointment code begins with “C”, this may indicate that the appointment was missed due to company reasons. For example, a code “CF” may indicate that company facilities were not available, e.g., because cable was not in the ground for a new subdivision, etc.). If a user is conducting research on due dates missed for company reasons, then the user may request that the SOCS data report return to me all orders only a “C %” miss (% being a wild card). This avoids the need to look at every order, when there may be thousands of orders, and allows the user to direct his/her attention to only orders missed for company reasons.

The missed appointment code field 410a and the other fields shown on the screenshot 400 are shown by way of example. There may be different fields, depending on the needs of the user. When the SOCS data report is run, the field headings don't change, but the data within the columns under the field headings may change. This allows the user to search for orders meeting specific criteria without having to look at every order.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A system for creating a service order control system report, the system comprising:
a service order control system database stored at a storage device; and
at least one server, wherein the at least one server is in communication with the service order control system database, the server further comprising a service order control system report generating application, the service order control system report generating application being configured to deliver service order control system data from the at least one server based upon input received at a remotely located computer system that is in communication with the at least one server.

2. The system of claim 1, wherein service order control system data is delivered from the service order control system database to the at least one server at predetermined time intervals.

3. The system of claim 2, wherein the service order control system report generating application generates the service order control system status report based upon the received service order control system data.

4. The system of claim 3, wherein an output configuration of the service order control system report is determined responsive to user input specifying at least one data field that is to be reported within the service order control system status report.

5. The system of claim 4, wherein the service order control system status report is presented for display at a display device that is in communication with the computer system.

6. The system of claim 4, wherein the service order control system status report is output in a predetermined file format.

7. The system of claim 4, wherein the service order control system status report is prioritized based upon a predetermined report service type that is associated with the service order control system status report.

8. A method for creating a service order control system report, the method comprising:
receiving service order control system data from a service order control system database;
configuring an output format for a service order control system status report by determining at least one data field that will be comprised within the service order control system status report;
retrieving the service order control system data that is respectively associated with each data field comprised within the service order control system status report; and
generating the service order control system status report.

9. The method of claim 8, further comprising receiving the service order control system data from the service order control system database at a predetermined time interval.

10. The method of claim 9, further comprising prioritizing the service order control system status report based upon a predetermined report service type that is associated with the service order control system status report.

11. The method of claim 10, further comprising associating the service order control system status report with a system user that created the service order control system status report.

12. The method of claim 11, further comprising presenting the generated service order control system status report for display at a display device.

13. The method of claim 11, further comprising outputting the service order control system status report in a predetermined file format.

14. The method of claim 13, further comprising exporting the service order control system status report file to a predetermined application.

15. A computer program product that includes a computer readable medium useable by a processor, the medium having stored thereon a sequence of instructions which, when executed by the processor, causes the processor to create a service order control system report by:
receiving service order control system data from a service order control system database;
receiving input in regard to configuring an output format for the service order control system status report, wherein the input comprises information detailing at least one data field that will be comprised within the service order control system status report;
retrieving the service order control system data that is respectively associated with each data field comprised within the service order control system status report; and
generating the service order control system status report.

16. The computer program product of claim 15, wherein the service order control system data is received from the service order control system database at a predetermined time interval.

17. The computer program product of claim 16, wherein the service order control system status report is prioritized based upon a predetermined report service type that is associated with the service order control system status report.

18. The computer program product of claim 17, wherein the service order control system status report is associated with a system user that created the service order control system status report.

19. The computer program product of claim 18, wherein the generated service order control system status report is presented for display at a display device.

20. The computer program product of claim 18, wherein the service order control system status report is output in a predetermined file format.
